(19) United States
(12) Patent Application Publication
(10) Pub. No.: US 2025/0266668 A1
(43) Pub. Date: Aug. 21, 2025

(54) CABLE CLIP CONFIGURED TO FACILITATE A DESIRED ALIGNMENT OF THE CABLE CLIP RELATIVE TO ANOTHER CABLE CLIP AND PROVIDE ENHANCED INSTALLATION FLEXIBILITY

(71) Applicant: PPC BROADBAND, INC., East Syracuse, NY (US)

(72) Inventors: Gabriel OSEI, East Syracuse, NY (US); Noah MONTENA, Syracuse, NY (US); Jordan CAVINESS, Liverpool, NY (US); Andrew BAUM, York, NY (US); Henry SAUVAIN, Syracuse, NY (US)

(73) Assignee: PPC BROADBAND, INC., East Syracuse, NY (US)

(21) Appl. No.: 19/053,627

(22) Filed: Feb. 14, 2025

Related U.S. Application Data
(60) Provisional application No. 63/554,593, filed on Feb. 16, 2024.

(51) Int. Cl. H02G 3/32; F16L 3/137; F16L 3/22

(52) U.S. Cl. CPC H02G 3/32; F16L 3/137; F16L 3/221

(57) ABSTRACT

A cable clip structurally configured to facilitate a desired alignment of the cable clip relative to another cable clip and provide enhanced installation flexibility. The cable clip may include a cable capturing portion structurally configured to capture a communication cable, a mounting portion structurally configured to allow the cable clip to be mounted to a mounting surface after capturing the communication cable, and alignment portion structurally configured to interconnect the cable clip with a second cable clip to facilitate a desired alignment of the cable clip relative to the second cable clip during and after installment and to provide enhanced installation flexibility.

### CROSS-REFERENCE TO RELATED APPLICATION

This application claims the benefit of U.S. Provisional Application No. 63/554,593 filed Feb. 16, 2024, which is currently pending, the disclosure of which is hereby incorporated by reference herein in its entirety.

### TECHNICAL FIELD

The present disclosure relates generally to cable clips for attaching a cable to a mounting surface, and more particularly to a cable clip with an alignment portion structurally configured to facilitate a desired alignment of a cable clip relative to another cable clip and provide enhanced installation flexibility.

### BACKGROUND

Cell towers, sometimes referred to as cell sites, are electric communications structures with mounted antennas that allow the surrounding area to use wireless communication devices like cell phones and tablets. While the communication signals are sent wirelessly from the antennas to the wireless communication devices in the area, communication cables (e.g., fiber conduit) are used to connect individual towers together via a cable network. These communication cables are routed up the tower to connect to the antennas. Cable clips that mount to the cell tower provide an attachment and cable management point for communication cables on cell tower installations.

Conventional cable clips can lack installation flexibility by requiring technicians to affix the clips to the designated area before placing the conduit in the clip; thus, potentially resulting in nearly irreversible errors. Further, in some implementations, conventional clips do not provide a way to facilitate a desired alignment of multiple clips after installment.

It may be desirable to provide a cable clip that is configured to facilitate a desired alignment of the cable clip relative to another cable clip, for example, another like cable clip. It may be desirable to provide a cable clip that provides technicians with increased flexibility during installation and a way to facilitate a desired alignment of cable clips relative to each other after installment.

### SUMMARY

The present disclosure provides a cable clip for attaching a communication cable to a mounting surface. In some implementations, the cable clip may be structurally configured to facilitate a desired alignment of the cable clip relative to another cable clip and provide enhanced installation flexibility.

In some embodiments, the cable clip may include a mounting portion structurally configured to facilitate mounting the cable clip to a mounting surface. In some embodiments, the mounting portion may include an engagement portion structurally configured to engage the mounting surface. In some embodiments, the mounting portion may include an attachment portion structurally configured to facilitate attaching the cable clip to the mounting surface.

In some embodiments, the attachment portion may include a first fastener receiving portion structurally configured to receive a first fastener and a second fastener receiving portion, opposite the first fastener receiving portion, structurally configured to receive a second fastener. In some embodiments, the first and second fastener receiving portions may be laterally offset from a longitudinal axis of the cable clip.

In some embodiments, the cable clip may include a cable supporting portion structurally configured to support a communication cable on the cable clip.

In some embodiments, the cable clip may include a cable retaining portion structurally configured to receive the communication cable and to resist the communication cable being withdrawn from the cable clip.

In some embodiments, the cable clip may include an alignment portion structurally configured to interconnect the cable clip with a second cable clip. In some embodiments, the alignment portion may include a recessed portion and a projecting portion, wherein the recessed portion is structurally configured to receive a second projecting portion of the second cable clip and the projecting portion is structurally configured to be received in a second recessed portion of the second cable clip;

In some embodiments, the cable clip may include a linking portion structurally configured to link the cable clip to a third cable clip as a unitary structure. In some embodiments, the linking portion may include a connecting portion having an area of weakness structurally configured to be fractured to decouple the cable clip from the third cable clip.

In some embodiments, the mounting portion may be structurally configured to allow the cable clip to be mounted to the mounting surface after the communication cable is captured in the cable retaining portion.

In some embodiments, the alignment portion may be structurally configured to facilitate a desired alignment of the cable clip relative to the second cable clip during and after installment and to provide enhanced installation flexibility.

In some embodiments, the attachment portion may include a third fastener receiving portion structurally configured to define a path, transverse to the longitudinal axis, for receiving a fastening strip between the engagement portion and the cable retaining portion.

In some embodiments, the cable supporting portion may include a concave surface structurally configured to receive the communication cable and the cable retaining portion includes a plurality of fingers structurally configured to bracket the cable supporting portion.

In some embodiments, a cable clip may be structurally configured to facilitate a desired alignment of the cable clip relative to another cable clip and provide enhanced installation flexibility.

In some embodiments, the cable clip may include an attachment portion structurally configured to facilitate attaching the cable clip to a mounting surface, a cable supporting portion structurally configured to support a communication cable on the cable clip, and a cable retaining portion structurally configured to receive the communication cable and to resist the communication cable being withdrawn from the cable clip.

In some embodiments, the cable clip may include an alignment portion structurally configured to interconnect the cable clip with a second cable clip. In some embodiments, the alignment portion may include a recessed portion and a projecting portion, wherein the recessed portion is structurally configured to receive a second projecting portion of the second cable clip and the projecting portion is structurally configured to be received in a second recessed portion of the second cable clip.

In some embodiments, the cable clip may include a linking portion structurally configured to link the cable clip to a third cable clip as a unitary structure. In some embodiments, the linking portion may include a connecting portion structurally configured to allow the cable clip to be decoupled from the third cable clip.

In some embodiments, the attachment portion may be structurally configured to allow the cable clip to be attached to the mounting surface after capturing the communication cable in the cable capturing portion.

In some embodiments, alignment portion may be structurally configured to facilitate a desired alignment of the cable clip relative to the second cable clip during and after installment and to provide enhanced installation flexibility.

In some embodiments, the cable supporting portion may include a concave surface structurally configured to receive the communication cable and the cable retaining portion includes a plurality of projecting portions structurally configured to bracket the cable supporting portion.

In some embodiments, the attachment portion may include a first flange portion and a first fastener receiving portion on the first flange portion that is structurally configured to receive a first fastener of the one or more fasteners, wherein the first fastener receiving portion is laterally offset from a longitudinal axis of the cable clip.

In some embodiments, the attachment portion may include a second flange portion opposite the first flange portion and a second fastener receiving portion on the second flange portion structurally configured to receive a second fastener of the one or more fasteners, wherein the second fastener receiving portion is laterally offset from the longitudinal axis of the cable clip.

In some embodiments, the attachment portion may include a third fastener receiving portion structurally configured to define a path, transverse to the longitudinal axis, for receiving a fastening strip between the cable retaining portion and an engagement portion that is structurally configured to engage the mounting surface to support the cable clip on the mounting surface.

In some embodiments, the connecting portion may include an area of weakness structurally configured to be fractured to decouple the cable clip and the third cable clip.

In some embodiments, a cable clip may be structurally configured to facilitate a desired alignment of the cable clip relative to another cable clip and provide enhanced installation flexibility.

In some embodiments, the cable clip may include a mounting portion structurally configured to mount to a mounting surface, a cable capturing portion structurally configured to capture a communication cable, and an alignment portion structurally configured to interconnect the cable clip with a second cable clip.

In some embodiments, the alignment portion may include a recessed portion and a projecting portion. In some embodiments, the recessed portion may be structurally configured to receive a second projecting portion of the second cable clip and the projecting portion may be structurally configured to be received in a second recessed portion of the second cable clip.

In some embodiments, the mounting portion may be structurally configured to allow the cable clip to be mounted to the mounting surface after capturing the communication cable in the cable capturing portion.

In some embodiments, the alignment portion may be structurally configured to facilitate a desired alignment of the cable clip relative to the second cable clip during and after installment and to provide enhanced installation flexibility.

In some embodiments, the cable capturing portion may include a cable supporting portion structurally configured to support a communication cable on the cable clip and a cable retaining portion structurally configured to receive the communication cable and to resist the communication cable being withdrawn from the cable clip.

In some embodiments, the cable supporting portion may include a concave surface structurally configured to receive the communication cable and the cable retaining portion includes a plurality of projecting portions structurally configured to bracket the cable supporting portion.

In some embodiments, the mounting portion may include an engagement portion structurally configured to engage the mounting surface to support the cable clip on the mounting surface and an attachment portion structurally configured to facilitate attaching the cable clip to the mounting surface with one or more fasteners.

In some embodiments, the attachment portion may include a first flange portion and a first fastener receiving portion on the first flange portion that is structurally configured to receive a first fastener of the one or more fasteners, wherein the first fastener receiving portion is laterally offset from a longitudinal axis of the cable clip.

In some embodiments, the attachment portion may include a second flange portion opposite the first flange portion and a second fastener receiving portion on the second flange portion structurally configured to receive a second fastener of the one or more fasteners, wherein the second fastener receiving portion is laterally offset from the longitudinal axis of the cable clip.

In some embodiments, the attachment portion may include a third fastener receiving portion structurally configured to define a path, transverse to the longitudinal axis, for receiving a fastening strip between the engagement portion and the cable retaining portion.

In some embodiments, the cable clip may include a linking portion structurally configured to link the cable clip to a third cable clip as a unitary structure.

In some embodiments, the linking portion may include a connecting portion structurally configured to allow the cable clip to be decoupled from the third cable clip.

In some embodiments, the connecting portion may include an area of weakness structurally configured to be fractured to decouple the cable clip and the third cable clip. In some embodiments, the area of weakness includes at least one of perforations or a recessed portion.

Various aspects of the system, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

The accompanying drawings, which are incorporated in and constitute a part of this specification, illustrate embodiments of the present teachings and together with the description, serve to explain the principles of the present teachings.

FIG. 1 is an isometric view of an example cable clip in accordance with various aspects of the disclosure.

FIG. 2 is an end view of the cable clip of FIG. 1.

FIG. 3 is a top view of the cable clip of FIG. 1 with a cable installed.

FIG. 4 is an enlarged view of an alignment portion of the cable clip of FIG. 1

FIG. 5 is a perspective view of a group of cable clips attached to a mounting surface.

FIG. 6 is a top view of a group of interconnected cable clips.

FIG. 7 is an enlarged top view of the interconnection portion of two adjacent cable clips.

FIG. 8 is an enlarged side view of the interconnection portion of two adjacent cable clips.

FIG. 9 is a top view of two groups of cable clips arranged in an offset configuration.

FIG. 10 is a perspective view of two groups of cable clips arranged in an offset configuration attached to a mounting surface.

FIG. 11 is a perspective view of an example cable clip in accordance with various aspects of the disclosure.

FIG. 12 is a top view of the cable clip of FIG. 11 with a cable installed.

FIG. 13 is a perspective view of two cable clips connected to each other.

### DETAILED DESCRIPTION

Reference will now be made in detail to presently preferred embodiments and methods of the present disclosure, which constitute the best modes of practicing the present disclosure presently known to the inventors. The figures are not necessarily to scale. It is to be understood, however, that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

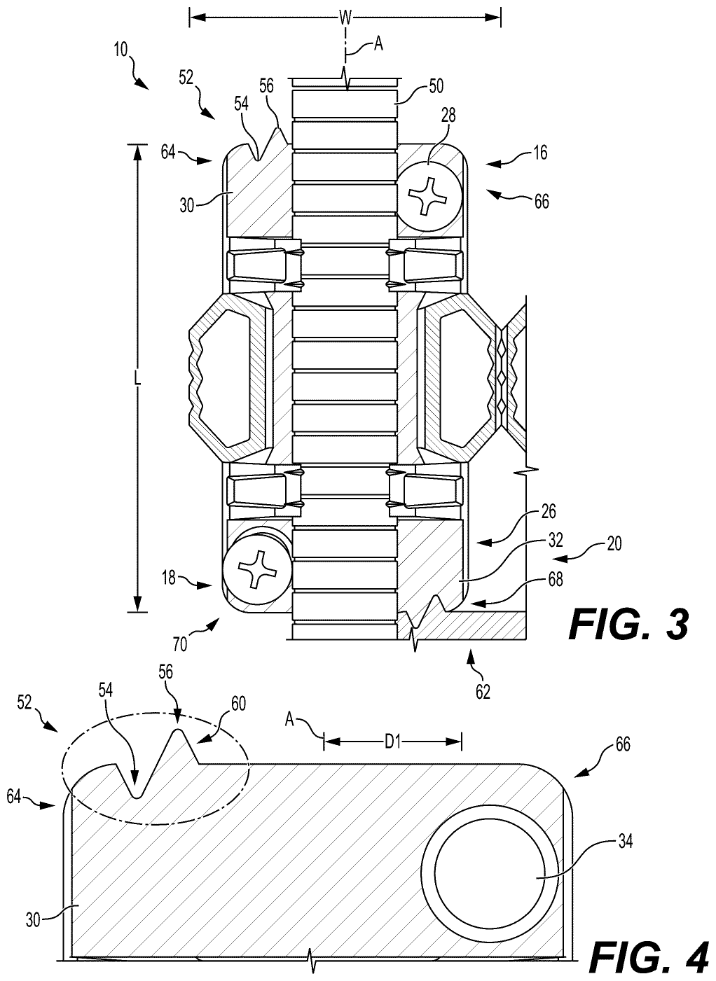

Implementations of the disclosure provide a cable clip 10 for attaching a communication cable 12 (e.g., a fiber optic cable) (FIG. 3) to a mounting surface 14. As used in this application, the term “communication cable” includes a duct, conduit, or sheathing that is structurally configured to receive a fiber optic cable, coaxial cable, or the like. For example, FIG. 3 illustrates a conduit captured by the cable clip. Thus, in some implementations, the cable clip 10 may be structurally configured to capture a duct, conduit, or sheathing for receiving a fiber optic cable, coaxial cable, or the like and/or may be structurally configured to capture the fiber optic cable, coaxial cable, etc.

In some implementations, the cable clip 10 may be structurally configured to interconnect with one or more adjacent, like cable clips to facilitate a desired alignment of a plurality of the cable clips relative to each other after installment. Thus, in some implementations, the cable clip may be structurally configured to ensure a desired alignment relative to another cable clip. In some implementations, the cable clip 10 may be structurally configured to allow a user to mount the cable clip 10 both before the communication cable 12 has been captured by the cable clip 10 or after the cable has been captured by the cable clip 10.

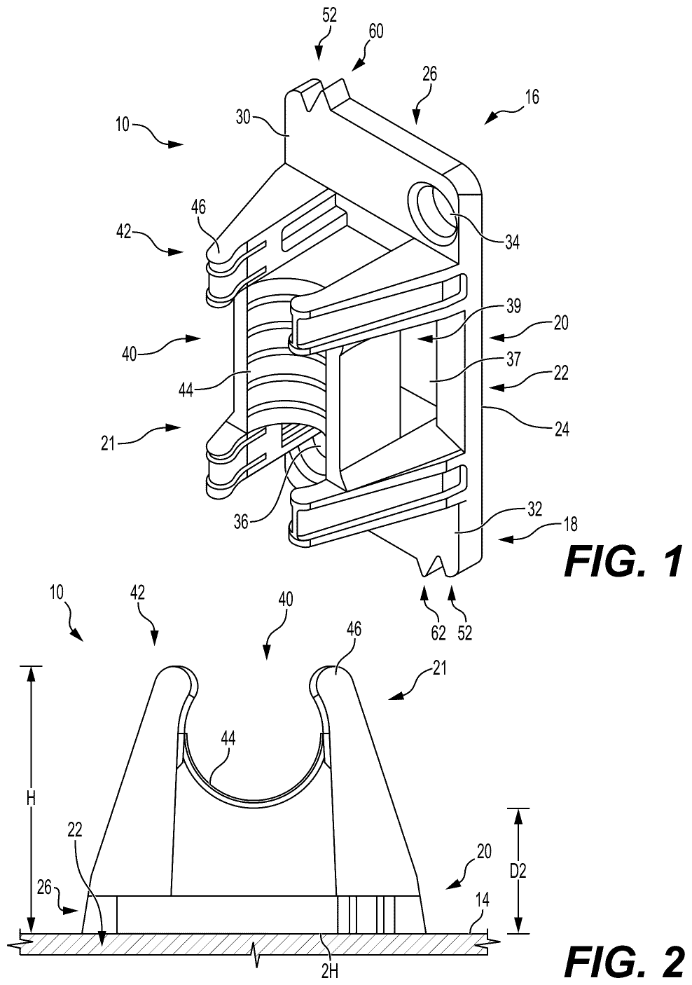

The cable clip 10 may be configured in a variety of ways, including shape, size, materials used, etc. Referring to FIGS. 1-3, in some implementations, the cable clip 10 may include a first end portion 16, a second end portion 18 opposite the first end portion 16, a central longitudinal axis A (FIG. 3) extending from the first end portion 16 to the second end portion 18, a width W, a height H, and a length L. In some implementations, the cable clip 10 may include a mounting portion 20 and a cable capturing portion 21.

The mounting portion 20 may be structurally configured to facilitate mounting the cable clip 10 to the mounting surface 14 (see FIG. 2). In some implementations the mounting portion 20 may be structurally configured to allow the cable clip 10 to mount to the mounting portion 20 both before the communication cable 12 is captured by the cable clip 10 and after the communication cable 12 is captured by the cable clip 10.

The mounting portion 20 may be configured in a variety of ways. In some implementations, the mounting portion 20 may include an engagement portion 22. The engagement portion 22 may be structurally configured to engage the mounting surface 14 to support the cable clip 10 on the mounting surface 14. In other implementations, however, the engagement surface 24 may be other than planar. In some implementations, the engagement surface 24 may have a generally rectangular profile. In other implementations, however, the engagement surface 24 may be any suitable shape (e.g., oval, circular, trapezoidal, etc.).

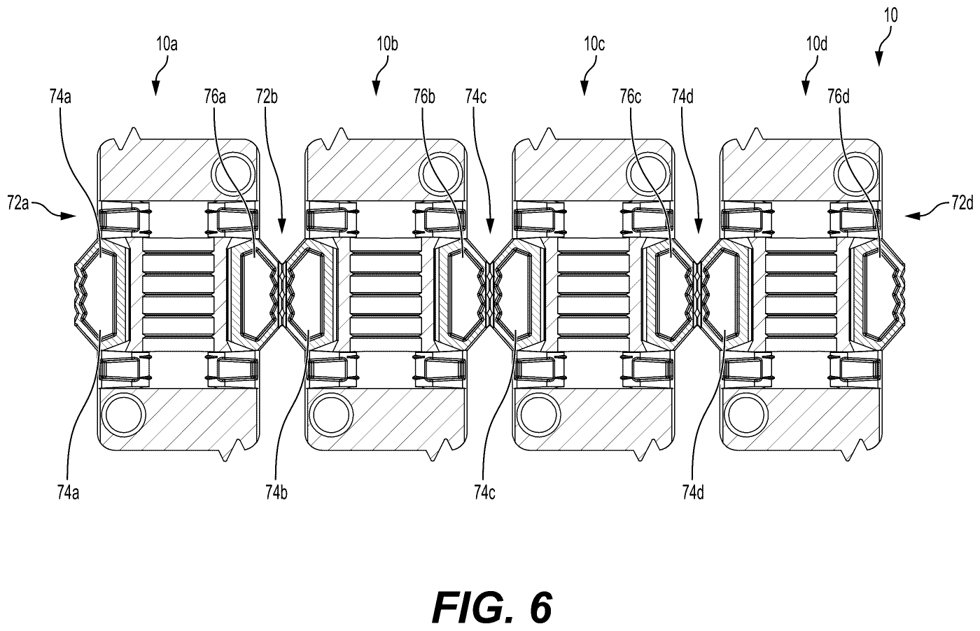

In some implementations, the mounting portion 20 may include an attachment portion 26 structurally configured to facilitate attaching the cable clip 10 to the mounting surface 14 with one or more fasteners 28 (e.g., screws, straps, nails, cable ties, etc.). The attachment portion 26 may be configured in a variety of ways. In some implementations, the attachment portion 26 may include a first flange portion 30 at, or proximal to, the first end portion 16 and a second flange portion 32 at, or proximal to, the second end portion 18. As shown in FIGS. 1 and 6, in some implementations, the attachment portion 26 may include a first fastener receiving portion 34 on the first flange portion 30 and a second fastener receiving portion 36 on the second flange portion 32.

In some implementations, the attachment portion 26 may be structurally configured to allow the one or more fasteners 28 to attach the cable clip 10 to the mounting surface 14 while the communication cable 12 is captured by the cable capturing portion 21. For example, in some implementations, the first fastener receiving portion 34 may be positioned offset a first distance D1 from the longitudinal axis A of the cable clip 10 (FIG. 4). The first distance D1 may be sufficient to allow a first of the one or more the fasteners 28 to be received within the first fastener receiving portion 34 and engaged with the mounting surface 14 to secure the cable clip 10 to the mounting surface 14 while the communication cable 12 is captured by the cable capturing portion 21.

In some implementations, the second fastener receiving portion 36 may be likewise offset from the longitudinal axis A to allow a second of the one or more the fasteners 28 to be received within the second fastener receiving portion 36 and engaged with the mounting surface 14 to secure the cable clip 10 to the mounting surface 14 while the communication cable 12 is captured by the cable capturing portion 21.

In some implementations, the second fastener receiving portion 36 may be offset the same first distance D1 as the first fastener receiving portion 34. In other implementations, however, the second fastener receiving portion 36 may be offset a different distance. In some implementations, the first fastener receiving portion 34 may be offset in a first direction relative to the longitudinal axis A and the second fastener receiving portion 36 may be offset in a second direction opposite the first direction.

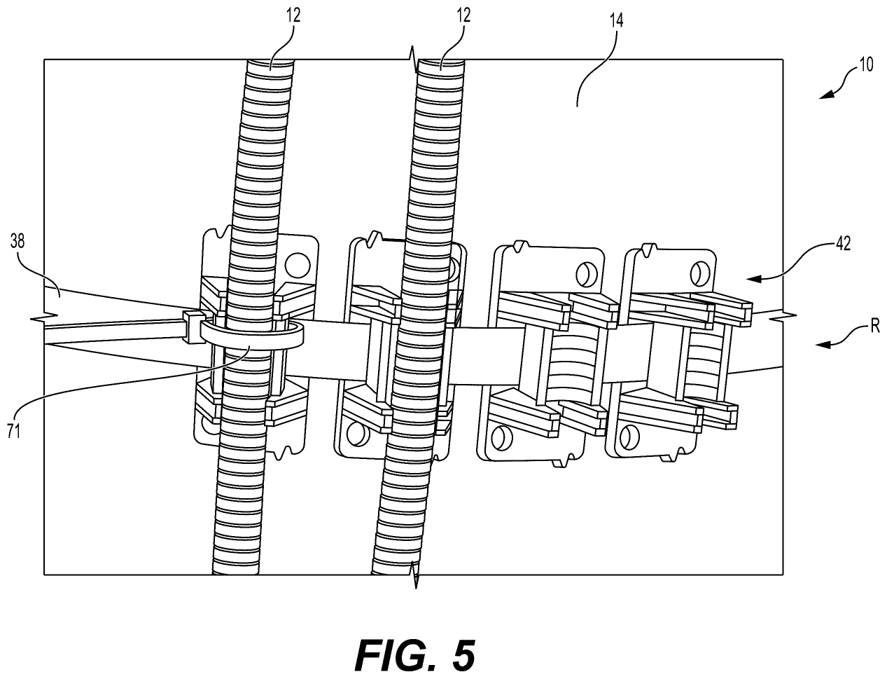

In some implementations, the attachment portion 26 may include a third fastener receiving portion 37 structurally configured to receive one or more fastening strips 38 (e.g., bands, straps, belts, wires, cable ties, etc.) (FIG. 5) to attach the cable clip 10 to the mounting surface 14. In some implementations, the third fastener receiving portion 37 may define a path 39 for receiving the one or more fastening strips 38 between the engagement portion 22 and the cable capturing portion 21. For example, in some implementations, the third fastener receiving portion 37 may be a slot and the path 39 may extend traverse (e.g., perpendicular) to the longitudinal axis A of the cable clip 10. Thus, the one or more fastening strips 38 may be received through the third fastener receiving portion 37 along the path 39 and extend traverse (e.g., perpendicular) to the longitudinal axis A of the cable clip 10.

The cable capturing portion 21 may be configured in a variety of ways. In some implementations, the cable capturing portion 21 may include a cable supporting portion 40 and a cable retaining portion 42. The cable supporting portion 40 may be structurally configured to support the communication cable 12 on the cable clip 10. In some implementations the cable supporting portion 40 may be structurally configured to support the communication cable 12 a second distance D2 from the mounting surface 14.

The cable supporting portion 40 may be configured in a variety of ways. In some implementations, the cable supporting portion 40 may include a concave surface 44 (e.g., semicircular or U-shaped cross-sectional profile). In some implementations, the cable supporting portion 40 may be structurally configured to support the communication cable 12 on the cable clip 10 such that the communication cable 12 extends parallel to the longitudinal axis A. In some implementations, the cable supporting portion 40 may include one or more features structurally configured to resist movement (e.g., axial movement and/or rotational movement) of the captured communication cable 12 relative to the cable supporting portion 40. For example, in some implementations, the concave surface 44 may be textured (e.g., ridges, bumps, etc.) that engage the communication cable 12 to resist movement of the communication cable 12 relative to the concave surface 44. In some implementations, the communication cable 12 may include corresponding structure on an exterior surface 50 that engage the features on the cable supporting portion to resist relative movement (e.g., grooves on the exterior surface configured to engage ridges on the concave surface 44 or vice versa).

The cable retaining portion 42 may be structurally configured to resist the cable being withdrawn from the cable clip 10 once captured. The cable retaining portion 42 may be configured in a variety of ways. In some implementations, the cable retaining portion 42 may be structurally configured to allow the communication cable 12 to snap into the cable clip 10 and engage the cable supporting portion 40. For example, some implementations, the cable retaining portion 42 may be structurally configured to flex outward when the communication cable 12 is snaped into the cable clip 10 and then flex back inward to resist the communication cable 12 from being withdrawn from the cable clip 10. The cable retaining portion 42 may be made from any suitable material (e.g., plastic, hard rubber, etc.) that allows the cable retaining portion 42 to flex outward when the communication cable 12 is snaped into the cable clip 10 and then flex back inward to resist the communication cable 12 from being withdrawn from the cable clip 10.

In some implementations, the cable retaining portion 42 may include a plurality of projecting portions 46 (e.g., fingers) extending away from the cable supporting portion 40 (i.e., in direction opposite the mounting portion 20). For example, in some implementations, the cable retaining portion 42 may include four projecting portions 46 structurally configured to bracket the cable supporting portion 40 (e.g., extend upward from four corners of the cable supporting portion 40. In some implementations, the projecting portions 46 may be curved inward. In some implementations, the concave surface 44 and the projecting portions 46 may be curved to complement an exterior surface 50 (FIG. 3) of the communication cable 12.

In some implementations, the cable clip 10 may include an alignment portion 52 structurally configured to interconnect or interlink two or more adjacent, like cable clips to facilitate a desired alignment of the two or more cable clips relative to each other during and after installment. The alignment portion 52 may be configured in a variety of ways, including method of interconnecting, location, size, shape, orientation, alignment, etc.

In some implementations, the alignment portion 52 may include structure on a periphery of the cable clip 10 that may be structurally configured to interact or engage complimentary structure on a second cable clip. In some implementations, the alignment portion 52 may be associated with (e.g., located on or adjacent to) the mounting portion 20. In some implementations, the alignment portion 52 may be located on one or both of the first flange portion 30 and the second flange portion 32.

In some implementations, the alignment portion 52 may include a recessed portion 54 and a protruding portion 56. In some implementations, the recessed portion 54 and the protruding portion 56 are arranged adjacent each other. In some implementations, the alignment portion 52 may include a first recessed portion and protruding portion pair 60 positioned on the first flange portion 30 and a second recessed portion and protruding portion pair 62 positioned on the second flange portion 32.

In some implementations, the first recessed portion and protruding portion pair 60 may be located at, or proximal to, a first corner 64 of the mounting portion 20. In some implementations, the first fastener receiving portion 34 may be located at, or proximal to, a second corner 66 of the mounting portion 20 wherein the first corner 64 is opposite the second corner 66. Likewise, in some implementations, the second recessed portion and protruding portion pair 62 may be located at, or proximal to, a third corner 68 of the mounting portion 20. In some implementations, the second fastener receiving portion 36 may be located at, or proximal to, a fourth corner 70 of the mounting portion 20 wherein the third corner 68 is opposite the fourth corner 70.

Referring to FIG. 5, a plurality of cable clips 10 are shown attached side-by-side in a row R. In some embodiments, the mounting surface 14 may be convex. In other implementations, the cable clips 10 can be attached to a mounting surface 14 with any suitable shape (e.g., planar, concave, uneven, etc.). In the illustrated example, four cable clips 10 are shown attached to the mounting surface 14 by the fastening strips 38. In some implementations, the plurality of cable clips 10 may be attached to the mounting surface 14 by receiving the fastening strips 38 through the third fastener receiving portion 37 along the path 39 (FIG. 1) of each cable clip 10. Thus, in some implementations, a single fastening strips 38 may attach a plurality of cable clips 10 to the mounting surface 14.

In some implementations, each of the plurality of cable clips 10 can be individually attached to the mounting surface 14 via the fastening strips 38 (FIG. 3) and the first and second fastener receiving portions 34, 36 as described above. In some implementations, one of, or both of, the fasteners 28 and the fastening strips 38 may be used to attach the cable clips 10 to the mounting surface 14.

In some implementations, a fastener 71 (e.g., a band, a strap, a belt, a strip, a cable tie, etc.) may be used to assist in retaining the communication cable 12 in the cable retaining portion 42. For example, in some implementations, the fastener 71 may be received through the third fastener receiving portion 37 along the path 39 between the engagement portion 22 and the cable capturing portion 21 (FIG. 1) and wrap around the communication cable 12 received in the cable retaining portion 42, as shown in FIG. 5. Thus, while the cable retaining portion 42 may be structurally configured to retain the communication cable 12 in the cable clip 10, the fastener 71 may provide an additional way for retaining the communication cable 12.

As shown in FIGS. 6-8, the cable clip 10 may include a linking portion 72 structurally configured to link the cable clip 10 to one or more adjacent cable clips 10. The linking portion 72 may be structurally configured in a variety of ways. In some implementations, the linking portion 72 may be structurally configured such that two or more cable clips 10 may be formed as a unitary structure (e.g., molded together as two or more connected cable clips 10). In some implementations, the linking portion 72 may be structurally configured to link the cable clip 10 to one or more adjacent cable clips 10 in a side-by-side arrangement. In some implementations, the linking portion 72 may be structurally configured to be fractured or broken to separate the cable clip 10 from one or more adjacent cable clips 10.

FIG. 6 illustrates a group of four connected cable clips 10. In particular, a first cable clip 10a, a second cable clip 10b, a third cable clip 10c, and a fourth cable clip 10d are interconnected. In other implementations, however, more or less than four cable clips 10 may be interconnected.

In some implementations, the first cable clip 10a may include a first linking portion 72a having a first lateral portion 74a and a second lateral portion 76a opposite the first lateral portion 74a. Likewise, the second cable clip 10b may include a second linking portion 72b having a first lateral portion 74b and a second lateral portion 76b opposite the first lateral portion 74b, the third cable clip 10c may include a third linking portion 72c having a first lateral portion 74c and a second lateral portion 76c opposite the first lateral portion 74c, and the fourth cable clip 10d may include a fourth linking portion 72d having a first lateral portion 74d and a second lateral portion 76d. opposite the first lateral portion 74d.

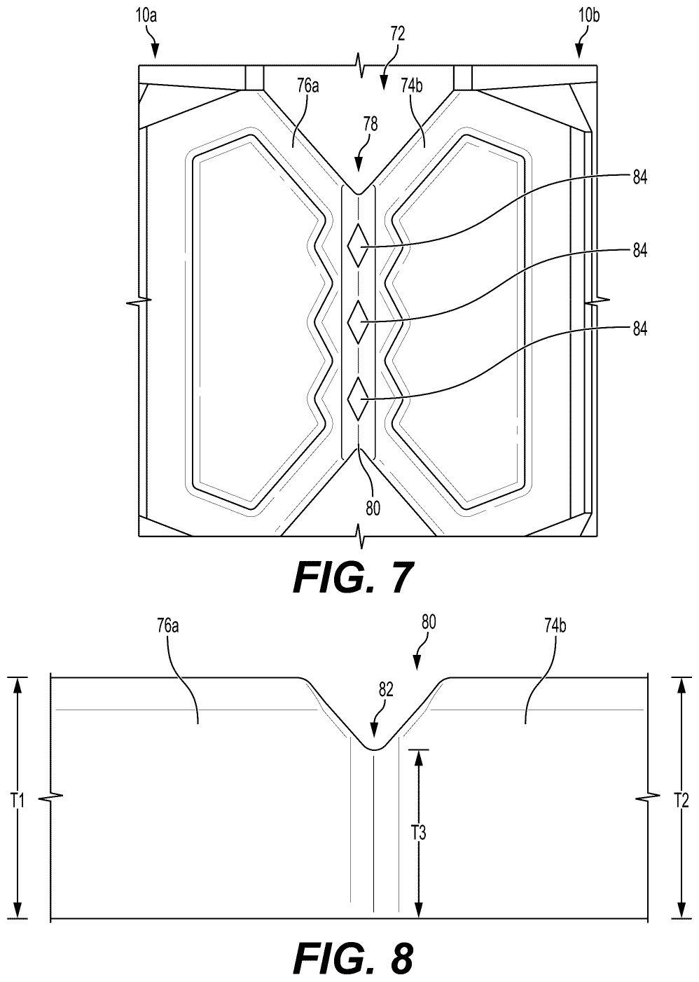

As shown in FIG. 7, in some implementations, the first linking portion 72a of the first cable clip 10a may be connected to the second linking portion 72b of the second cable clip 10b. In particular, in some implementations, the second lateral portion 76a of the first cable clip 10a may be connected to the first lateral portion 74b of the second cable clip 10b. The second lateral portion 76a may be connected to the first lateral portion 74b in a variety of ways. For example, in some implementations the second lateral portion 76a may be connected to the first lateral portion 74b by a connecting portion 78 structurally configured allow the first cable clip 10a and the second cable clip 10b to be separated when desired.

The connecting portion 78 may be configured in a variety of ways. In some implementations, the connecting portion 78 forms a line or an area of weakness 80 (e.g., thinner area, perforated area, creased area, notched area, or other weakened area) structurally configured to be fractured to unlink the first cable clip 10a and the second cable clip 10b. For example, in some implementations, the connecting portion 78 may be thinner than surrounding areas (i.e., the adjacent lateral portions). For example, referring to FIG. 7, in some implementations, the second lateral portion 76a of the first cable clip 10a has a first thickness T1, the first lateral portion 74b of the second cable clip 10b has a second thickness T2, and the connecting portion 78 has a third thickness T3 that may be less than the first thickness T1 and/or the second thickness T2. In some implementations, the first thickness T1 and the second thickness T2 may be the same or substantially similar.

In some implementations, the connecting portion 78 may have a recessed portion 82 defining the thinner third thickness T3. The recessed portion 82 may be any suitable shape and size. For example, in some implementations, the recessed portion 82 may be a triangular notch extending along the connecting portion 78 between the first cable clip 10a and the second cable clip 10b. In some implementations, the connecting portion 78 may include one or more perforations 84. The one or more perforations 84 may be configured in a variety of ways, including the number of perforations, the shape and the size of the perforations, the arrangement of the perforations, etc. In some implementations, the connecting portion 78 may include three, spaced-apart, diamond-shaped perforations 84 arranged in series along the along the connecting portion 78.

The second cable clip 10b may be connected to and separable from the third cable clip 10c and the third cable clip 10c may be connected to and separable from the fourth cable clip 10d in the same manner as described above regarding the first cable clip 10a being connected to and separable from the second cable clip 10b.

In some implementations, the connecting portions 78 form flexible or bendable connections between the connected cable clips 10 in the group. For example, the implementation of FIG. 5 illustrates four separated cable clips 10 mounted to the convex mounting surface 14. In other implementations, however, the cable clips 10 may be connected via the linking portions 72 and mounted as a unitary structure onto the mounting surface 14. Since the connecting portions 78 may form flexible or bendable connections, the connected cable clips 10 may mount onto a convex, concave, or otherwise curved surface in addition to a planar surface.

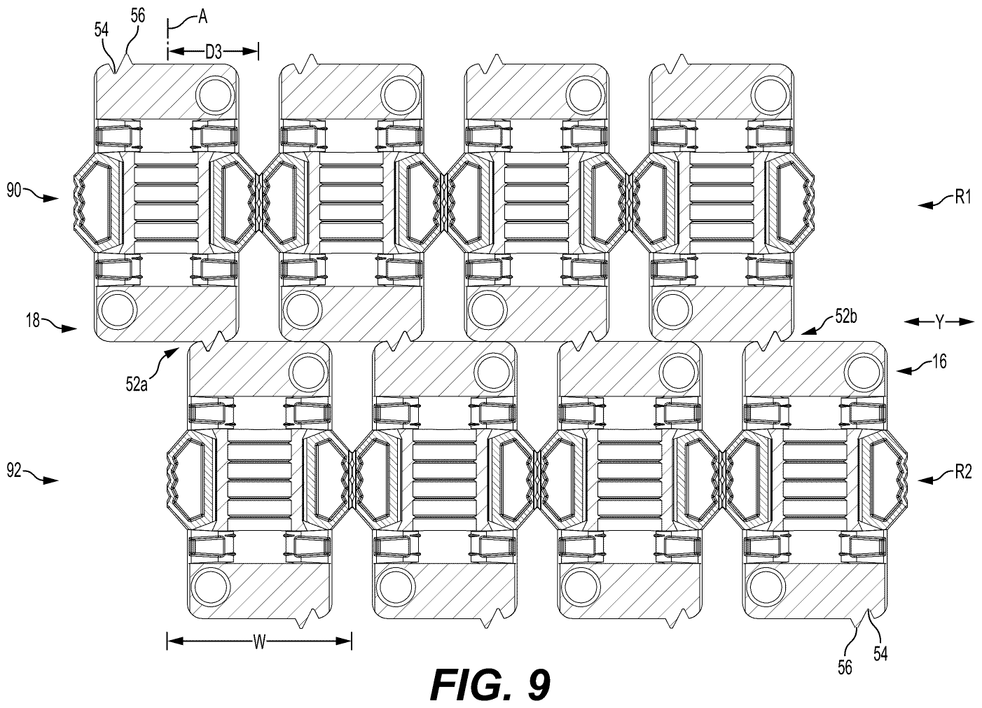

In some implementations, a plurality of cable clips 10 may be arranged proximal or adjacent each other. For example, FIG. 9 illustrates a first group 90 of the cable clips 10 arranged in a first row R1 and a second group 92 of the cable clips 10 arranged in a second row R2 proximal the first row R1 such that the alignment portions 52a of the first group 90 of the cable clips 10 engage the alignment portions 52b of the second group 92 of the cable clips 102. In the illustrated example, the first group 90 of the cable clips 10 may be formed as a first unitary structure of four cable clips 10 connected via the linking portions 72 as described above. Similarly, the second group 92 of the cable clips 10 may be formed as a second unitary structure of four cable clips 10 connected via linking portions 72 as described above. In other implementations, the first group 90 of the cable clips 10 and/or the second group 92 of the cable clips 10 may have more or less than four cable clips in each group and may have some or all of the cable clips within a group not connected.

As shown in FIG. 9, in some implementations, when the alignment portions 52a of the first group 90 of the cable clips 10 engage the alignment portions 52b of the second group 92 of cable clips 10, the recessed portions 54 and the projecting portions 56 at the second end portion 18 of the first group 90 of the cable clips 10 engage corresponding protruding portions 56 and recessed portions 54, respectively, at the first end portion 16 of the second group 92 of cable clips 10. Thus, lateral movement, as shown by arrow Y, of the first group 90 of the cable clips 10 relative to the second group 92 of the cable clips 10 may be restricted which helps to facilitate a desired alignment of the cable clips 10 relative to each other before and after installment.

Referring to FIG. 9, in some implementations, when the alignment portions 52a of the first group 90 of the cable clips 10 engage the alignment portions 52b of the second group 92 of the cable clips 10, the first group 90 of the cable clips 10 may be laterally offset a third distance D3 from the second group 92 of cable clips 10 such that the longitudinal axis A of a cable clip 10 of the first group 90 of the cable clips 10 extends between two cable clips 10 of the second group 92 of the cable clips 10 or is adjacent a cable clip 10 from the second group 92 of the cable clips 102. In some implementations, the distance D3 may be half the width W of the cable clips 10.

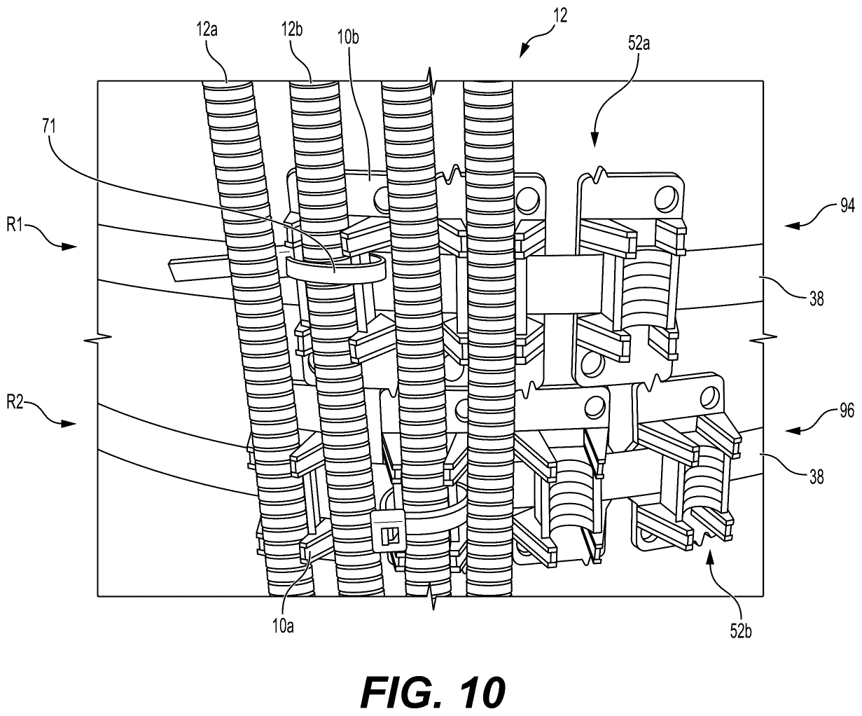

FIG. 10 illustrates an example of a plurality of cable clips 10 arranged proximal or adjacent each other. In some implementations, a first group 94 of the cable clips 10 may be arranged side-by-side in a first row R1 and a second group 92 of the cable clips 10 may be arranged side-by-side in a second row R2 proximal the first row R1. In some implementations, the first group 94 of the cable clips 10 may be laterally offset from the second group 96 of the cable clips 10. The cable clips 10 in each row may be formed as a unitary structure, as shown in FIG. 9, or one or more of the cable clips 10 in each row may be separated for the other cable clips 10 in the row. In some implementations, one or more alignment portions 52a of the cable clips 10 in the first row R1 may be engaged with a corresponding alignment portion 52b of a cable clip in the second row R2 to help facilitate a desired alignment of cable clips 10 relative to each other. In other implementations, however, the cable clips 10 may be arranged without the alignment portions 52 engaging, as shown in FIG. 10.

As shown in FIG. 10, each of the cable clips 10 in the two rows R1, R2 may be utilized to secure a corresponding communication cable 12. For example, a first communication cable 12a may be secured with the cable retaining portion 42 of a first of the cable clips 10a, a second communication cable 12b may be secured with the cable retaining portion 42 of a second cable clip 10b, and so one. In some implementations, each of the communication cables 12 may be secured by a corresponding fastener 71 in the same manner as described regarding the cable clips 10 in the example of FIG. 5.

In some implementations, the arrangement of the cable clips 10, as shown in FIG. 10, may be such that a communication cable 12 captured by a cable clip 10 in the first row R1 may extend between two cable clips 10 in the second row R2. In some implementations, the communication cable 12 captured by the cable clip 10 in the first row R1 may overlap one of the lateral portions 74, 76 (FIG. 6) of the two cable clips in the second row R2 that the communication cable 12 passes between. For example, the second distance D2 (FIG. 2) may be sufficient to raise the communication cable 12 above the lateral portions 74, 76 (FIG. 6) of each of the two cable clips in the second row R2 that the communication cable 12 passes between allowing for a more compact spacing between the cable clips 10 in the two rows R1, R2.

In some implementations, the one or more cable clips 10 in a first row R1 and/or the one or more cable clips 10 in a second row R2 may be secured to the mounting surface 14 in the same manner as described regarding the cable clips 10 in the example of FIG. 5 (i.e., with the fastening strips 38 and/or the fasteners 28).

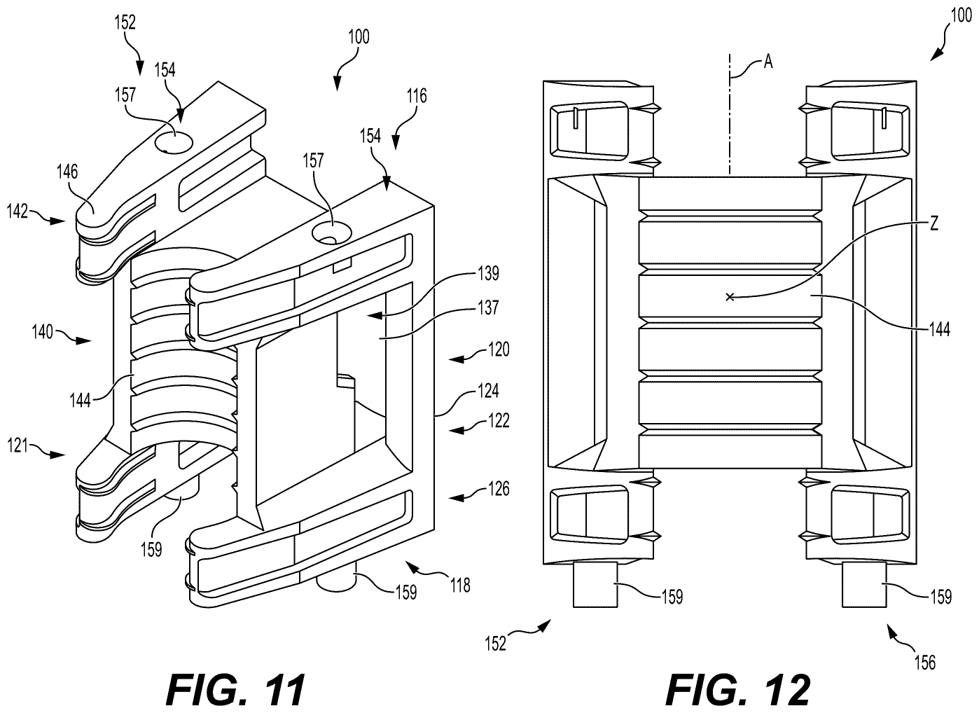

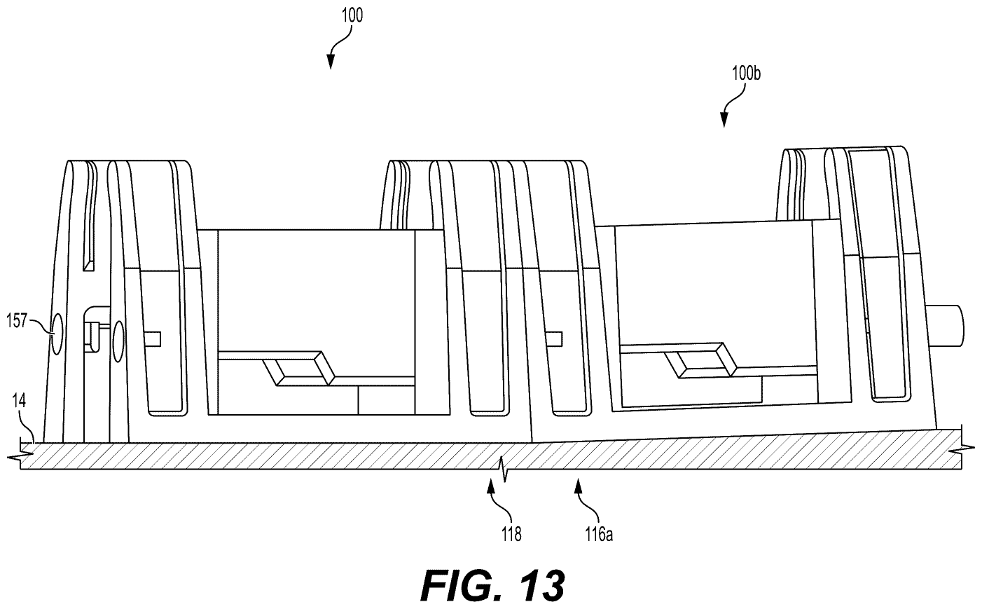

Referring to FIGS. 11-13, illustrate an example implementation of a cable clip 100 for attaching the communication cable 12 (e.g., FIG. 3) to the mounting surface 14 (FIG. 13). The cable clip 100 may be similar to the cable clip 10 of FIGS. 1-10. For example, the cable clip 100 may be structurally configured to interconnect with one or more adjacent, like cable clips to facilitate a desired alignment of a plurality of the cable clips relative to each other after installment.

In some implementations, the cable clip 100 may include a first end portion 116, a second end portion 118 opposite the first end portion 116, a central longitudinal axis A extending from the first end portion 116 to the second end portion 118. The cable clip 100 may include a mounting portion 120 and a cable capturing portion 121 the same, or similar to, the cable clip 10 of FIGS. 1-10. For example, the mounting portion 120 may include an engagement portion 122 structurally configured to engage the mounting surface 14 to support the cable clip 10 on the mounting surface 14 and an attachment portion 126 structurally configured to facilitate attaching the cable clip 10 to the mounting surface 14 with one or more fasteners (e.g., screws, straps, nails, cable ties, straps, bands, etc.) (not shown).

In some implementations, the engagement portion 122 may define a generally planar engagement surface 124. In some implementations, the attachment portion 126 may include a fastener receiving portion 137 structurally configured to receive a fastener (e.g., a band, a strap, a belt, a strip, a cable tie, etc.) to attach the cable clip 100 to the mounting surface 114. In some implementations, the fastener receiving portion 137 defines a path 139 for receiving the fastener between the engagement portion 122 and the cable capturing portion 121, similar to the fastener receiving portion 37 and path 39 of the cable clip 10. In some implementations, the path 139 may be traverse (e.g., perpendicular) to a longitudinal axis A of the cable clip 100.

The cable capturing portion 121 may include a cable supporting portion 140 structurally configured to support the communication cable 12 on the cable clip 100 and a cable retaining portion 142 structurally configured to resist the cable being withdrawn from the cable clip 100 once captured. In some implementations, the cable supporting portion 140 may include a surface 144 (e.g., a concave surface) structurally configured to support the communication cable 12 a distance above the mounting surface 14.

In some implementations, the cable retaining portion 142 may be structurally configured to allow the communication cable 12 to snap into the cable clip 100 and engage the cable supporting portion 140. For example, in some implementations, the cable retaining portion 142 may include a plurality of fingers 146 extending away from the cable supporting portion 140 (i.e., in direction opposite the mounting portion 20).

In some implementations, the attachment portion 126 may not include first and second flange portions like the first and second flange portions 30, 32 of the illustrated implementations of the cable clip 10. The cable clip 100, however, may still be attached to the mounting surface 14 with one or more fasteners in addition to, or as an alternative to, the fastener received though the fastener receiving portion 137. For example, in some implementations, the cable supporting portion 140 may be structurally configured to allow a fastener (e.g., a screw, a nail, etc.) to be driven through the surface 144 (e.g., at point Z in FIG. 12) and into the mounting surface 14 to secure the cable clip 100 to the mounting surface 14.

In some implementations, the cable clip 100 may include an alignment portion 152 structurally configured to interconnect or interlink two or more adjacent, like cable clips to facilitate a desired alignment of the two or more cable clips relative to each other during and after installment. The alignment portion 152 may be configured in a variety of ways, including method of interconnecting, location, size, shape, orientation, alignment, etc.

In some implementations, the alignment portion 152 may include a recessed portion 154 and a protruding portion 156. The recessed portion 154 may be structurally configured to receive a corresponding protruding portion on a second cable clip (not shown) and the protruding portion 156 may be structurally configured to be received in a corresponding recessed portion on a second cable clip (not shown). The recessed portion 154 and the protruding portion 156 may be configured in a variety of ways, such as for example, the shape, the size, the location on the cable clip, etc. In some implementations, the recessed portion 154 may include a pair of spaced apart recesses 157 positioned on the first end portion 116 and the protruding portion 156 may include a pair of spaced apart protruding portions 159 positioned on the second end portion 118. In other implementations, the recessed portion 154 and/or the protruding portion 156 may include more or less than a pair of recessed portions and a pair of protruding portions, respectively.

As shown in FIG. 13, in the illustrated implementation, the cable clip 100 may be connected, end-to-end, with a second cable clip 100b. For example, second end portion 118 of the cable clip 100 may be connected to the first end portion 116a of the second cable clip 100b such that the pair of spaced apart protruding portions 159 on the cable clip 100 may be received within a corresponding pair of recesses (e.g. recesses 157) (not shown) on the second cable clip 100b. In some implementations, the longitudinal axis A of the cable clip 100 may extend parallel to (e.g., coaxial with) a corresponding longitudinal axis (not shown) of the second cable clip 100b.

In some implementations, the recessed portion 154 and the projecting portion 156 are structurally configured to engage a corresponding projecting portion and recessed portion of additional cable clips with a friction fit that resist separating the cable clips once connected. Further, the alignment portion 152 may be structurally configured to resist relative movement (e.g., rotational movement, lateral movement, and longitudinal movement) between two connected cable clips or a series of connected cable clips. Thus, the alignment portion 152 may facilitate a desired alignment of the two or more interconnected cable clips relative to each other during and after installment.

While at least one example, non-limiting embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A cable clip structurally configured to facilitate a desired alignment of the cable clip relative to another cable clip and provide enhanced installation flexibility, comprising:
a mounting portion structurally configured to facilitate mounting the cable clip to a mounting surface, the mounting portion including an engagement portion structurally configured to engage the mounting surface and an attachment portion structurally configured to facilitate attaching the cable clip to the mounting surface;
a cable supporting portion structurally configured to support a communication cable on the cable clip;
a cable retaining portion structurally configured to receive the communication cable and to resist the communication cable being withdrawn from the cable clip;
an alignment portion structurally configured to align the cable clip relative to a second cable clip; and
a linking portion structurally configured to link the cable clip to a third cable clip as a unitary structure;
wherein the attachment portion includes a first fastener receiving portion structurally configured to receive a first fastener and a second fastener receiving portion, opposite the first fastener receiving portion, structurally configured to receive a second fastener, wherein the first and second fastener receiving portions are laterally offset from a longitudinal axis of the cable clip;
wherein the alignment portion includes a recessed portion and a projecting portion, wherein the recessed portion is structurally configured to receive a second projecting portion of the second cable clip and the projecting portion is structurally configured to be received in a second recessed portion of the second cable clip;
wherein the linking portion includes a connecting portion having an area of weakness structurally configured to be fractured to decouple the cable clip from the third cable clip; and
wherein the mounting portion is structurally configured to allow the cable clip to be mounted to the surface after capturing the communication cable in the cable capturing portion; and
wherein the alignment portion is structurally configured to facilitate a desired alignment of the cable clip relative to the second cable clip during and after installment and to provide enhanced installation flexibility.

2. The cable clip of claim 1, wherein the attachment portion includes a third fastener receiving portion structurally configured to define a path, transverse to the longitudinal axis, for receiving a fastening strip between the engagement portion and the cable retaining portion.

3. The cable clip of claim 1, wherein the cable supporting portion includes a concave surface structurally configured to receive the communication cable and the cable retaining portion includes a plurality of fingers structurally configured to bracket the cable supporting portion.

4. A cable clip structurally configured to facilitate a desired alignment of the cable clip relative to another cable clip and provide enhanced installation flexibility, comprising:
attachment portion structurally configured to facilitate attaching the cable clip to a mounting surface;
a cable supporting portion structurally configured to support a communication cable on the cable clip;
a cable retaining portion structurally configured to receive the communication cable and to resist the communication cable being withdrawn from the cable clip;
an alignment portion structurally configured to align the cable clip relative to a second cable clip; and
a linking portion structurally configured to link the cable clip to a third cable clip as a unitary structure;
wherein the linking portion includes a connecting portion structurally configured to allow the cable clip to be decoupled from the third cable clip;
wherein the alignment portion includes a recessed portion and a projecting portion, wherein the recessed portion is structurally configured to receive a second projecting portion of the second cable clip and the projecting portion is structurally configured to be received in a second recessed portion of the second cable clip;
wherein the attachment portion is structurally configured to allow the cable clip to be attached to the mounting surface after the communication cable is received in the cable retaining portion; and
wherein the alignment portion is structurally configured to facilitate a desired alignment of the cable clip relative to the second cable clip during and after installment and to provide enhanced installation flexibility.

5. The cable clip of claim 4, wherein the cable supporting portion includes a concave surface structurally configured to receive the communication cable and the cable retaining portion includes a plurality of projecting portions structurally configured to bracket the cable supporting portion.

6. The cable clip of claim 4, wherein the attachment portion includes a first flange portion and a first fastener receiving portion on the first flange portion that is structurally configured to receive a first fastener of the one or more fasteners, wherein the first fastener receiving portion is laterally offset from a longitudinal axis of the cable clip.

7. The cable clip of claim 6, wherein the attachment portion includes a second flange portion opposite the first flange portion and a second fastener receiving portion on the second flange portion structurally configured to receive a second fastener of the one or more fasteners, wherein the second fastener receiving portion is laterally offset from the longitudinal axis of the cable clip.

8. The cable clip of claim 7, wherein the attachment portion includes a third fastener receiving portion structurally configured to define a path, transverse to the longitudinal axis, for receiving a fastening strip between the cable retaining portion and an engagement portion that is structurally configured to engage the mounting surface to support the cable clip on the mounting surface.

9. The cable clip of claim 4, wherein the connecting portion includes an area of weakness structurally configured to be fractured to decouple the cable clip and the third cable clip.

10. A cable clip structurally configured to facilitate a desired alignment of the cable clip relative to another cable clip and provide enhanced installation flexibility, comprising:
a mounting portion structurally configured to mount to a mounting surface, a cable capturing portion structurally configured to capture a communication cable; and
an alignment portion structurally configured to align the cable clip relative to a second cable clip;
wherein the mounting portion is structurally configured to allow the cable clip to be mounted to the mounting surface after capturing the communication cable in the cable capturing portion; and
wherein the alignment portion is structurally configured to facilitate a desired alignment of the cable clip relative to the second cable clip during and after installment and to provide enhanced installation flexibility.

11. The cable clip of claim 10, wherein the cable capturing portion includes a cable supporting portion structurally configured to support a communication cable on the cable clip and a cable retaining portion structurally configured to receive the communication cable and to resist the communication cable being withdrawn from the cable clip.

12. The cable clip of claim 11, wherein the cable supporting portion includes a concave surface structurally configured to receive the communication cable and the cable retaining portion includes a plurality of projecting portions structurally configured to bracket the cable supporting portion.

13. The cable clip of claim 10, wherein the mounting portion includes an engagement portion structurally configured to engage the mounting surface to support the cable clip on the mounting surface and an attachment portion structurally configured to facilitate attaching the cable clip to the mounting surface with one or more fasteners.

14. The cable clip of claim 13, wherein the attachment portion includes a first flange portion and a first fastener receiving portion on the first flange portion that is structurally configured to receive a first fastener of the one or more fasteners, wherein the first fastener receiving portion is laterally offset from a longitudinal axis of the cable clip.

15. The cable clip of claim 14, wherein the attachment portion includes a second flange portion opposite the first flange portion and a second fastener receiving portion on the second flange portion structurally configured to receive a second fastener of the one or more fasteners, wherein the second fastener receiving portion is laterally offset from the longitudinal axis of the cable clip.

16. The cable clip of claim 15, wherein the attachment portion includes a third fastener receiving portion structurally configured to define a path, transverse to the longitudinal axis, for receiving a fastening strip between the engagement portion and the cable retaining portion.

17. The cable clip of claim 10, further comprising a linking portion structurally configured to link the cable clip to a third cable clip as a unitary structure.

18. The cable clip of claim 17, wherein the linking portion includes a connecting portion structurally configured to allow the cable clip to be decoupled from the third cable clip.

19. The cable clip of claim 18, wherein the connecting portion includes an area of weakness structurally configured to be fractured to decouple the cable clip and the third cable clip.

20. The cable clip of claim 19, wherein the area of weakness includes at least one of perforations or a recessed portion.

21. The cable clip of claim 10, wherein the alignment portion includes a recessed portion and a projecting portion, wherein the recessed portion is structurally configured to receive a second projecting portion of the second cable clip and the projecting portion is structurally configured to be received in a second recessed portion of the second cable clip;
